(19) United States
(12) Patent Application Publication
(10) Pub. No.: US 2011/0171614 A1
(43) Pub. Date: Jul. 14, 2011

(54) Code Communication Board

(76) Inventor: Ingrid Ilona Ebner-Herzog, (US)

(21) Appl. No.: 12/685,905

(22) Filed: Jan. 12, 2010

(51) Int. Cl. G09B 1/00

(52) U.S. Cl. 434/112

(57) ABSTRACT

Communication device for patients unable to speak and partially paralyzed but visually not impaired consisting of a code communication board equipped with letters, numbers and symbols visible for the patient and movable electromagnetic pointing device operated by the patient enabling him to indicating letters, numbers and phrases on the code communication board and by this mean compose messages to the caretaker.

### BACKGROUND OF THE INVENTION

1. Field of Invention

This present invention relates to communication equipment enabling patients who are unable to communicate verbally and partially paralyzed but can see and able to exercise some marginal force or movement with a body part and by this means control a pointing device aiming to a code communication board equipped with letters, numbers and symbols.

2. Description of Prior Art

No Prior Art known to be exists.

SUMMARY OF INVENTION

Communication device for patients unable to speak and partially paralyzed but visually not impaired consisting of a code communication board equipped with letters, numbers and symbols visible for the patient and movable electromagnetic pointing device operated by the patient to indicating chosen letters, numbers and phrases on the code communication board.

### BRIEF DESCRIPTION OF THE DRAWINGS

In accordance with this invention code communication board equipped with letters, numbers and symbols visible for patient that is unable to communicate orally but able to operate an electromagnetic pointing device indicating chosen letters, numbers and phrases. The following description is an example of the code communication board and the other features of the invention.

FIGS. 1 and 2 shows a possible arrangement of the code communication board 1. The board self may be of paper, cardboard, wood or other material easily movable into a position visible for the patient. The choice of material for the board 1 is not a limitation for this invention. The board is equipped with letters, numbers and phrases that have meaning for the patient's conditions thus relates to his needs, concerns and wishes such as “cold”, “pain”, “lift”, “please”, “left”, “right”, “up”, “down”, etc. The single letters can be used to compose words and sentences. The choices of letters and symbols on the code communication board 1 do not limit the validity of this invention.

In accordance with this invention the letters, numbers and phrases are arranged and grouped in a logical geometric pattern, for example inside a grid system 2 facilitating the orientation as well as the aiming with an electromagnetic pointing device 4. In accordance with this invention the grid rows and columns are named 3 identifying segments of the grid system 2 by visible symbols, letters or numbers making it possible for a paralyzed patient by giving for example “yes” or “no” eye, eyelid or other signals answering audible questions from a care taker to maneuver around on the code communication board 1 identifying the grid segment of his or her choice. This is like a coordinate system where each row and column has a specific number or name. The number of grid segments, their size and relative arrangement, coloring and grouping does not create a limitation for this invention.

In accordance of this invention the material of the code communication board 1 may be transparent or semitransparent providing readability both from the front or patient side 9 and from the back or care taker side 10.

In accordance with the invention the patient can use a touch tablet or other touch sensitive device 5 connected to the code communication board in stead of an electromagnetic pointer 4 to indicate a specific location on the code communication board. The exact wired or wireless electrical connection 11 and program ensuring the connection between the code communication board 1 and the touch tablet or sphere 5 is not a limitation for this invention.

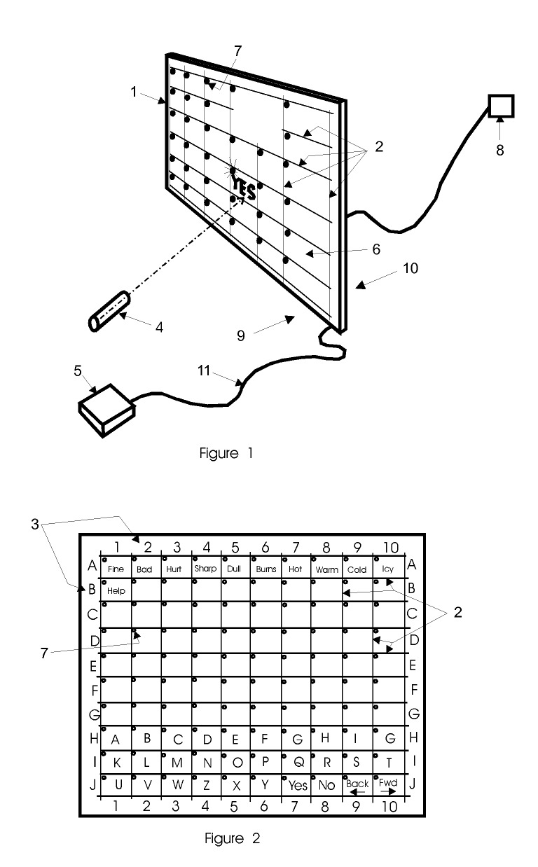

In accordance with this invention the code communication board 1 is equipped with electromagnetic wave sensitive sensors 6. For example, when the indicating light or laser beam reaches a specific segment of the code communication board 1, the respective local sensor 6 able to give a verifying feed-back light signal 7 to the patient as a kind of feed back or receipt for the reception. FIG. 1 shows an example where the patient pointed to the segment meaning “Yes” and the relevant feedback light 7 lights up. The sensor 6 can also send an electromagnetic or audible signal to another location, for example to the nurses' station 8. The detailed design and execution of this system of sensor 6, feedback signal 7 and communication 8 through wired or wireless connection to other location 8 is regarded as an expected skill of a technician and does not limit the validity of the invention.

What is claimed is:

1. Communication device for patients unable to speak and partially paralyzed consist of code communication board equipped with letters, numbers and symbols visible for the patient and movable electromagnetic pointing device indicating chosen letters, numbers and phrases on the code communication board.

2. Communication device in accordance with claim number 1 the code communication board is made of semi-transparent material.

3. Communication device in accordance with any of the foregoing claims the letters, numbers and phrases are arranged and grouped in a coordinate system with named and visible rows, columns and directions.

4. Communication device in accordance with any of the foregoing claims touch sensitive sensor operated by the patient is connected to the code communication board enabling the patient to choose letters, numbers and symbols on the code communication board.

5. Communication device in accordance with any of the foregoing claims the code communication board is equipped with individual electromagnetic wave sensitive sensors.

6. Communication device in accordance with any of the foregoing claims the code communication board's segment contains optical and audio signal giver activated when the patient chooses the segment.

7. Communication device in accordance with claim number 6 the electromagnetic signal is transferred to other location.
